(19) United States
(12) Patent Application Publication
(10) Pub. No.: US 2009/0007610 A1
(43) Pub. Date: Jan. 8, 2009

(54) Pivot Lever Lock Having Electrically Lockable Hand Lever

(76) Inventor: Rainer Hoffmann, Langenfeld (DE)

Correspondence Address: ROBERT W. BECKER & ASSOCIATES, 707 HIGHWAY 333, SUITE B, TIJERAS, NM, 87059-7507, US

(21) Appl. No.: 12/167,834

(22) Filed: Jul. 3, 2008

(30) Foreign Application Priority Data
Jul. 6, 2007 (DE) DE 202007009513.9

(51) Int. Cl. G05G 1/04

(52) U.S. Cl. 70/192

(57) ABSTRACT

A lock for doors, gates, lids and similar closure means, comprising a base plate that can be placed on the outer surface of a door panel and has an extension that extends through the panel. A hand lever is pivotably mounted to the base plate and can be accommodated therein. The hand lever can be locked via a locking mechanism in the position in which it is pivoted into the base plate. The locking mechanism is comprised of an electrically actuatable locking element disposed in the extension of the base plate. A lock cylinder is provided for also mechanically actuating the locking element.

The instant application should be granted the priority date of Jul. 6, 2007 the filing date of the corresponding German patent application DE 20 2007 009 513.9.

### BACKGROUND OF THE INVENTION

The present invention relates to a lock for doors, gates, lids and similar closure means and includes a base plate that can be placed upon an outer surface of the door panel for accommodating a hand lever that is mounted thereon and that can be locked, via a locking mechanism provided on the base plate, in a position in which it is pivoted into the base plate, whereby the locking mechanism is comprised of an electrically actuatable locking element that is disposed in an extension of the base plate that extends through the door panel.

A lock having the aforementioned features is described in DE 298 06 974 U1. The hand lever of the known pivot lever lock is provided on its free end with a lock extension that in the position of the hand lever where it is pivoted into the base plate projects into an extension disposed on the base pate. Pivotably mounted in the extension of the base plate is a locking element that is biased into its locking position by a spring; in this locking position, the locking element secures the locking extension of the hand lever in place when the hand lever is pivoted into the base plate. An electromagnet that can be supplied with current for the actuation is disposed in the extension of the base plate in such a way that when the electromagnet is energized it disengages the locking element from the locking extension of the hand lever, so that the hand lever is released and can be pivoted out of the base plate.

The known lock has the drawback that if the power supply fails, or the electromagnet malfunctions, it is not possible to actuate the hand lever and hence to open the door.

It is therefore an object of the present invention to provide a lock having the aforementioned features such that it is possible to open the door independently of the functioning of the electrical actuation of the hand lever locking mechanism.

### BRIEF DESCRIPTION OF THE DRAWINGS

This object, and other objects and advantages of the present invention, will appear more clearly from the following specification in conjunction with the accompanying schematic drawings, in which:

FIG. 1 is an exploded view of the individual components of a pivot lever lock having an electrically lockable hand lever and a mechanical override mechanism,

FIG. 2 is a cross-sectional view of the assembled lock of FIG. 1, and

FIG. 3 is a cross-sectional plan view of the lock of FIG. 2.

### SUMMARY OF THE INVENTION

The basic concept of the present invention is that the locking element, in addition to the electrically operating actuation, is adapted to be actuated by a mechanically operating lock cylinder.

The present invention has the advantage that due to the additionally provided, mechanically operating lock cylinder, an overriding closure of the electrically operating actuation for the locking element is possible if the electrically operating actuation, for example in the form of an electromagnet, fails. In this case, by closure of the lock cylinder by means of a key, the locking element can also be disengaged from the hand lever, so that also in this case the hand lever can be pivoted out of the base plate.

Pursuant to one embodiment of the present invention, the lock cylinder can be disposed in a protrusion housing that is mounted on the hand lever, in the pivoted-in position of the hand lever extends into the extension of the base plate, and is adapted to be engaged by the locking element.

The protrusion housing of the hand lever can be sealed relative to the base plate in its position where it is pivoted into the extension of the base plate by means of a seal that is disposed on the outer side of the protrusion housing. This ensures that the functional elements disposed in the interior of the extension of the base plate are now sealed against the entry of moisture, so that the inventive lock can also have an outdoor utilization.

Pursuant to an alternative embodiment, the lock cylinder, in addition to the locking element and its actuating means, can be disposed in the extension of the base plate, and a locking protrusion that is adapted to be engaged by the locking elements can be provided on the hand lever, as such a manner of construction is basically known from the aforementioned DE 298 06 974 U1.

With regard to the configuration of the locking element with actuating means, pursuant to one embodiment of the invention the locking element is comprised of a locking pin that is longitudinally displaceable in an electromagnet that forms the means for electrically actuating the locking element, wherein the locking pin is actuatable by an actuating pin that in turn is actuatable by the lock cylinder. In this connection, the electromagnet can be oriented in such a way relative to the protrusion housing or to the locking protrusion of the hand lever that the locking element is held in the locking position due to its own weight. Such an embodiment has the advantage that the overriding of the electrical actuation by the mechanically operating lock cylinder is facilitated since it is merely necessary to overcome the force of gravity that acts on the locking pin, without having to overcome additional spring forces as with the prior art.

Pursuant to another embodiment of the invention, the hand lever can be provided on its outer edge with a projecting portion that projects in the direction of the base plate and that in the position of the hand lever where the latter is pivoted into the base plate extends into a groove that extends all the way around and has a configuration that is matched to the base plate; in so doing, the lock is advantageously protected against vandalism since the hand lever positively engages in the base plate in such a way that it cannot be inappropriately, forcibly opened by means of a tool placed between the hand lever and the base plate. As a consequence of the labyrinth provided by means of the projecting portion and the groove, there is no place for such a tool to be applied.

If in an expedient manner the free end of the hand lever is provided with a finger zone that projects beyond the base plate and serves to facilitate actuation of the hand lever, this finger zone can be separated from the hand lever by a breaking point, so that if an attempt is made to forcibly open the hand lever, this finger zone breaks off and there is again no point of application for a forcible opening.

Furthermore, pursuant to another embodiment of the present invention, the lock cylinder can be covered by means of a cover plate that is secured either to the hand lever or to the base plate, whereby the cover plate can be secured by means of mounting means that are adapted to be manipulated by a special tool. In this way, also the mechanical actuation of the locking mechanism for the hand lever via the lock cylinder is not possible without difficulty, thereby providing an additional protection for the lock.

Due to the combination of the measures described above, the inventive lock is particularly suitable for outdoor use.

Further specific features of the present invention will be described in detail subsequently.

### Description of Specific Embodiments

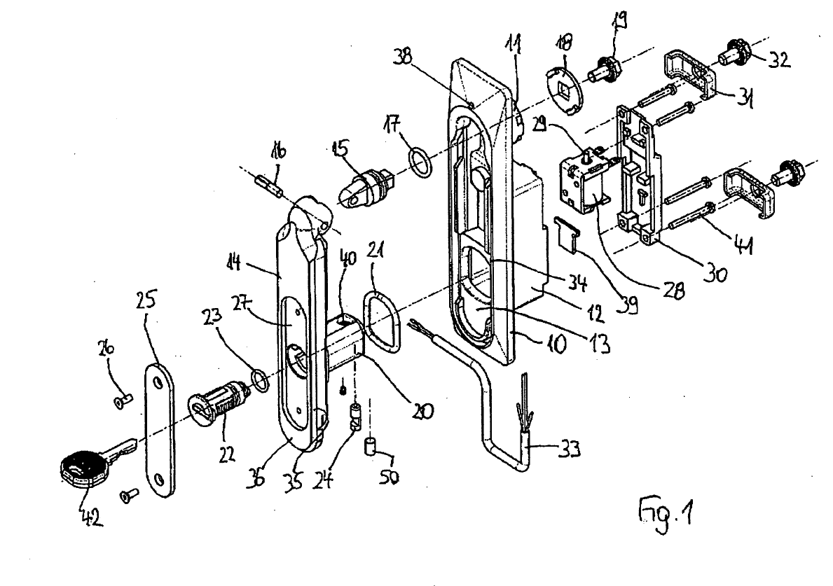

Referring now to the drawings in detail, as can be seen from FIG. 1 a trough or base plate 10 is provided that can be placed upon the outer side of a non-illustrated door panel in such a way that an extension 12 disposed on the base plate 10, as well as a bearing housing 11 for a grip or hand lever 14, extend through the door panel in at least one opening provided therefor. On its front side, which faces away from the extension 12 and the bearing housing 11, the base plate 10 is provided with a recess or depression 13 for accommodating the hand lever 14 therein in a recessed or counter sunk manner. For its support, a hinge mandrel or bolt 15 is attached to the hand lever 14 via a mounting pin 16, whereby the hinge mandrel 15 is passed through the bearing housing 11 of the base plate 10 and is sealed relative to the bearing housing via a seal 17. On the back side of the base plate 10, a rotation limiting means 18 is secured to the hinge mandrel 15 via a screw 19. A non-illustrated closing means, for example in the form of a casement fastener tongue, establishes the closing function of the lock.

Formed on the hand lever 14 is a protrusion housing 20 that projects in the direction of the base plate 10 and which in the pivoted-in position of the hand lever 14 extends into the extension 12 of the base plate 10. Disposed on the outer side of the protrusion housing 20 is a seal 21 that in the pivoted-in position establishes a sealing of the protrusion housing 20 relative to the extension 12 of the base plate 10.

A lock cylinder 22 is disposed in the protrusion housing 20 and is sealed relative to the protrusion housing via a seal 23. Disposed in the protrusion housing 20, perpendicular to the axis of the lock cylinder 22, is a linearly moveable actuating pin 24 that is engaged by the lock cylinder 22 and, by means of an eccentric member formed on the lock cylinder, is linearly displaceable in a manner to be described subsequently.

The access to the lock cylinder 22 disposed in the hand lever 14 is covered by a cover plate 25 that can be placed in a form fitting manner in a recessed area 27 formed on the front side of the hand lever 14, and that can be secured in position thereon via mounting means 26. These mounting means are configured in such a way that they can be loosened only with a special tool, thus making unauthorized access to the lock cylinder 22 more difficult.

For the locking of the hand lever 14 with the protrusion housing 20 in the extension 12 of the base plate 10, a solenoid or electromagnet 28, as an electrical actuation of the locking mechanism, is disposed in the extension 12, whereby a locking pin 29 is longitudinally displaceably disposed in the electromagnet 28. If the electromagnet 28 is de-energized, the locking pin 29, due to its own weight, engages into a locking opening 40 that is formed in the protrusion housing 20, thereby holding the protrusion housing in the position in which it is recessed in the extension 12 of the base plate 10. The extension 12 is closed off by a rear cover 30, which can be secured to the extension 12 by means of mounting screws 41. To secure the base plate 10 to the non-illustrated door panel, holding plates 31 are finally provided that can be secured in place on the base plate 10 via mounting screws 32, whereby the non-illustrated door panel is clamped between the holding plates 31 and the body of the base plate 10.

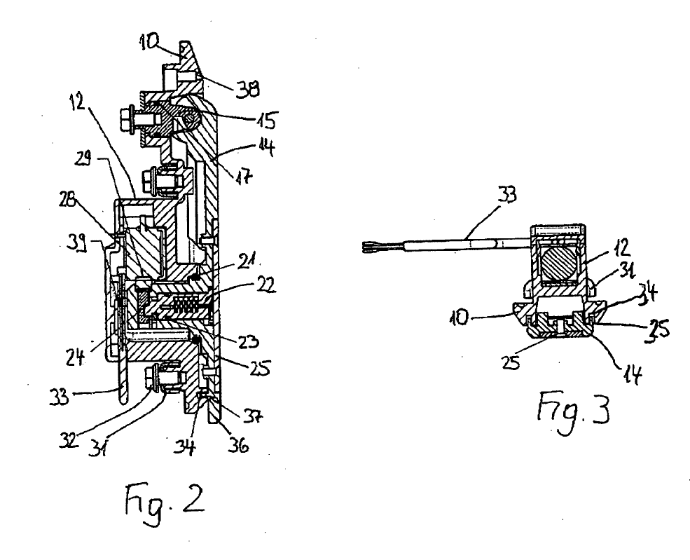

As can be seen in particular from FIG. 3, a labyrinth-like, interlocking or positive connection of the hand lever 14 with the base plate 10 in the pivoted-in position of the hand lever is provided in that the hand lever 14 is provided with a projecting portion 35 that extends all the way around and that, in the pivoted-in position of the hand lever illustrated in FIG. 3, engages in a groove 34 formed on the base plate 10. If the lower end of the hand lever 14 is provided with a finger zone 36 for actuation thereof, this finger zone is separated via a breaking point 37 (FIG. 2). These measures provide a protection against vandalism in that the positive connection between hand lever 14 and base plate 10 prevents a tool from being inserted into an otherwise present gap between hand lever and base plate to thereby pivot the hand lever up. This possibility no longer exists due to the labyrinth-like connection. Should such an attempt be undertaken in the lower region of the finger zone 26, the finger zone breaks off at the breaking point 37, so that also in this manner there is no holding possibility for an unauthorized pivoting-out of the hand lever 14.

The lock of the present application is completed by an LED 38 that is disposed above the recess 13 for the hand lever 14 and via which the operating state of the electrically actuated lock can be recognized. For this purpose a reed contact 39 having a permanent magnet 50 is disposed on the rear cover 30; via actuation of the permanent magnet the locking state can be recognized. The LED 38 indicates whether the handle can be opened.

If current is supplied to the electromagnet 28, which is connected via an electrical line 33 to a control structure disposed externally of the lock, the electromagnet 28 attracts the locking pin 29 and raises it out of the locking opening 40 of the protrusion housing 20 of the hand lever 14, so that the hand lever can be pivoted out of the recess 13. If for whatever reason the electromagnet 28 does not operate, after removal of the cover plate 25 the lock cylinder 22 can be actuated via a key 42; the eccentric lock cam of the lock cylinder that engages in the actuating pin 24 raises the actuating pin in the direction of the electromagnet 28, thereby disengaging the locking pin 29 from the protrusion housing 20. In this connection the movement paths of the actuating pin 24 on the one hand, and the locking pin 29 on the other hand, are coordinated with one another in such a way that their contact location with the surface of the protrusion housing 20 are aligned, so that in the raised position of the actuating pin 24, the protrusion housing 20, and hence the hand lever 14, are released from the locking pin 29.

The features of the subject matter of these documents disclosed in the preceding specification, the claims and the drawings can be important individually as well as in any combination with one another for realizing the various embodiments of the invention.

The specification incorporates by reference the disclosure of German priority document DE 20 2007 009 513.9 filed Jul. 6, 2007.

The present invention is, of course, in no way restricted to the specific disclosure of the specification and drawings, but also encompasses any modifications within the scope of the appended claims.

What I claim is:

1. A lock for a closure means, comprising:
a base plate, which is adapted to be placed upon an outer surface of a panel of the closure means, wherein said base plate is provided with an extension that is adapted to extend through the panel;
a hand lever pivotably mounted to said base plate and adapted to be accommodated in said base plate;
a locking mechanism provided on said base plate, wherein said hand lever is adapted to be locked via said locking mechanism in a position in which said lever is pivoted into said base plate, further wherein said locking mechanism is comprised of an electrically actuatable locking element disposed in said extension of said base plate;
a means for electrically actuating said locking element; and
a lock cylinder for mechanically actuating said locking element.

2. A lock according to claim 1, wherein a protrusion housing is mounted on said hand lever, further wherein said lock cylinder is disposed in said protrusion housing, further wherein in said position of said hand lever in which it is pivoted into said base plate said protrusion housing extends into said extension of said base plate, and wherein said protrusion housing is adapted to be engaged by said locking element.

3. A lock according to claim 2, wherein a seal is disposed on an outer side of said protrusion housing of said hand lever, further wherein said protrusion housing is adapted to be sealed relative to said base plate by means of said seal when said protrusion housing is in its pivoted-in position in said extension of said base plate.

4. A lock according to claim 1, wherein in addition to said locking element and said means for actuating said locking element, said lock cylinder is adapted to be disposed in said extension of said base plate, further wherein a locking protrusion is provided on said hand lever, and wherein said locking protrusion is adapted to be engaged by said locking element.

5. A lock according to claim 1, wherein said means for electrically actuating said locking element comprises an electromagnet, further wherein said locking element comprises a locking pin that is adapted to be longitudinally displaceable in said electromagnet, further wherein an actuating pin is provided that is adapted to be actuated by said lock cylinder, and wherein said locking pin is adapted to be actuated by said actuating pin.

6. A lock according to claim 5, wherein said electromagnet is oriented relative to a protrusion housing or a locking protrusion of said hand lever in such a way that said locking element is held in a locking position by means of the weight of said locking element.

7. A lock according to claim 1, wherein said hand lever is provided on an outer edge with a projecting portion that projects in a direction toward said base plate, and wherein in the position of said hand lever where it is pivoted into said base plate said projecting portion extends into a groove that is provided in said base plate, extends all the way around, and has a configuration that is matched to said base plate.

8. A lock according to claim 7, wherein a free end of said hand lever is provided with a finger zone, further wherein said finger zone projects beyond said base plate, and wherein said finger zone is adapted to be broken off by means of a breaking point.

9. A lock according to claim 1, wherein a cover plate is secured to said hand lever or to said base plate for covering said lock cylinder.

10. A lock according to claim 9, wherein said cover plate is secured to said hand lever or to said base plate via mounting means (26) that are adapted to be manipulated by means of a special tool.
